(19) United States
(12) Patent Application Publication
(10) Pub. No.: US 2011/0060869 A1
(43) Pub. Date: Mar. 10, 2011

(54) LARGE CAPACITY SOLID-STATE STORAGE DEVICES AND METHODS THEREFOR

(75) Inventor: Franz Michael Schuette, Colorado Springs, CO (US)

(73) Assignee: OCZ TECHNOLOGY GROUP, INC., San Jose, CA (US)

(21) Appl. No.: 12/876,937

(22) Filed: Sep. 7, 2010

Related U.S. Application Data
(60) Provisional application No. 61/240,338, filed on Sep. 8, 2009.

(51) Int. Cl. G06F 12/02; G06F 12/00; G06F 1/12

(52) U.S. Cl. 711/103; 713/400; 711/E12.001; 711/E12.008

(57) ABSTRACT

Non-volatile storage devices and methods capable of achieving large capacity SSDs containing multiple banks of memory devices. The storage devices include a printed circuit board, at least two banks of non-volatile solid-state memory devices, bank switching circuitry, a connector, and optionally a memory controller. The bank switching circuitry is functionally interposed between the banks of memory devices and either the connector or the memory controller. The bank switching circuitry operates to switch accesses by a system logic or the memory controller among the at least two banks.

### CROSS REFERENCE TO RELATED APPLICATIONS

This application claims the benefit of U.S. Provisional Application No. 61/240,338, filed Sep. 8, 2009, the contents of which are incorporated herein by reference.

### BACKGROUND OF THE INVENTION

The present invention generally relates to memory devices for use with computers and other processing apparatuses. More particularly, this invention relates to high capacity non-volatile or permanent memory-based mass storage devices of the type known as solid state drives (SSD).

Mass storage devices such as advanced technology (ATA) or small computer system interface (SCSI) drives are rapidly adopting non-volatile memory technology such as flash memory or other emerging solid state memory technology, including phase change memory (PCM), resistive random access memory (RRAM), magnetoresistive random access memory (MRAM), ferromagnetic random access memory (FRAM), organic memories, or nanotechnology-based storage media such as carbon nanofiber/nanotube-based substrates. Currently the most common technology uses NAND flash memory as inexpensive storage memory.

Current solid state drives (SSDs) are limited in their capacity by the density of the NAND chips in conjunction with the limitations of the control logic, that is, the memory controller. Even if the memory management unit is aware of a large memory space through, for example, a 48-bit large block addressing scheme, the actual controller will typically have limitations in the number of address lines or chip-selects, which then limits the overall capacity of the device to a much smaller size. For example, using an eight-channel interleaved flash memory controller and 32 Gbit ICs, the maximum capacity of a single unit SSD is currently 256 GB.

In the past, the cost of NAND flash memory was prohibitive for even considering ultra-high capacity solid state drives, but with production ramping up and NAND cost decreasing on average by 50% per year, SSDs have not only gained acceptance in the market but are also constantly increasing in capacity. Decreasing acquisition cost in conjunction with much lower power consumption (low operational cost) results in a lower total cost of ownership (TCO). The lower TCO combined with the mechanical robustness of SSDs have created a need for a type of SSD with ultra high capacity.

Current solutions to overcome the size limitations posed by limited density of NAND flash memory ICs and the limited number of chip select lines on the controller employ bundling of several SSDs within a single package and functionally integrating them into a spanned volume or into a striped RAID array (Level 0). An example of such an SSD 10 is schematically represented in FIG. 1, which shows a printed circuit board 12 equipped with a power and data connector 14 and multiple memory chips 18. The connector 14 provides a system interface by which the SSD 10 can be connected to a cable of a host computer system (not shown). The memory chips 16 are typically flash (e.g., NAND) non-volatile memory chips or another non-volatile memory technology. FIG. 1 further represents the capacity of the SSD 10 as increased by effectively consolidating two separate SSDs on the circuit board 12, represented as two separate arrays (banks) 16 of the memory chips 18, each with a dedicated control logic (controller) 20 (represented as integrated circuit (IC) chip), and further interfaced with the computer system through a RAID controller 22, typically through a Level 0 striped configuration.

The type of configuration represented in FIG. 1 has the advantage of ease of configurability and, in most cases, allows some additional management features such as the selection of the type of array, meaning JBOD, RAID Level 0 or RAID Level 1 (striping or mirroring, respectively). On the downside, this arrangement incurs the additional cost for the RAID controller 22 as well as the second SSD controller 20, typically a Serial ATA (SATA) to NAND flash memory controller, with an extra volatile cache (not shown). Functionally, the RAID 0, as the most commonly used, will not be able to play out the combined transfer rates of two drives because the system interface (connector 14) is usually a single SATA link, which limits the host transfer rate and can cause some problems if the combined internal media transfer rate at the back-end of the SSD 10 is greater than the host transfer rate.

### BRIEF DESCRIPTION OF THE INVENTION

The present invention provides non-volatile storage devices and methods capable of achieving large capacity SSDs containing multiple banks of memory devices.

According to a first aspect of the invention, a non-volatile storage device is provided for use with a host system. The storage device includes a printed circuit board, at least two banks of non-volatile solid-state memory devices on the printed circuit board, a single memory controller adapted to interface with the memory devices and a host bus adapter of the host system, and bank switching circuitry functionally interposed between the memory controller and the at least two banks of the memory devices. The bank switching circuitry operates to switch accesses by the memory controller among the at least two banks.

According to a second aspect of the invention, a non-volatile mass storage device is provided for use with a host system. The mass storage device includes a printed circuit board, at least two banks of non-volatile solid-state memory devices on the printed circuit board, a connector adapted to receive address and control signals from a system logic of a host system, and bank switching circuitry on the printed circuit board and adapted to receive the address and control signals directly from the connector and split at least some of the address and control signals between the at least two banks of the memory devices.

Another aspect of the invention is a method of increasing the addressable memory space of a non-volatile storage device comprising a printed circuit board, at least two banks of non-volatile solid-state memory devices on the printed circuit board, a single memory controller, and a bank switching circuitry. The method includes using the memory controller to interface with a host bus adapter of a host system and the memory devices, and using the bank switching circuitry to multiply memory space within the memory devices that is addressable by the memory controller by the number of the at least two banks.

Still another aspect of the invention is a method of increasing the addressable memory space of a non-volatile solid-state memory card comprising a printed circuit board, at least two banks of non-volatile solid-state memory devices, a connector, and bank switching circuitry. The method includes using the connector to receive address and control signals from a system logic of a host system, and using the bank switching circuitry to multiply the memory space addressable by the system logic by the number of the at least two banks.

From the above it can be appreciated that, according to certain aspects of the invention, a large capacity SSD can be provided that is capable of using a single conventional SSD controller. In combination with the bank switching circuitry, the controller can be operated to translate a small address space into several physical address spaces, each using its own bank of memory devices. As a result, a significant advantage made possible with this invention is that the desired capacity of an SSD can exceed the addressing space of its memory controller.

It can also be appreciated that, according to other aspects of the invention, the bank switching circuitry can be implemented on a flash memory card that is interfaced with a memory controller integrated on the system level, such that the bank switching circuitry receives address and control signals from the system logic of a host system. These signals can then be split by the bank switching circuitry between the banks of memory devices.

Each of the capabilities described above is achieved using the bank switching circuitry to duplicate address lines and act as an intermediate buffer for memory addresses before propagating them to multiple banks of memory devices. As a result, the invention enables at least doubling of the capacity of an SSD without the need of an extra controller in an internal redundant array of independent drives (RAID) Level 0 configuration.

Other aspects and advantages of this invention will be better appreciated from the following detailed description.

### BRIEF DESCRIPTION OF THE DRAWINGS

FIG. 1 schematically represents a prior art RAID Level 0 configuration using a RAID controller with two functional SSDs integrated on a single circuit board to overcome the address limitation of a single SSD controller.

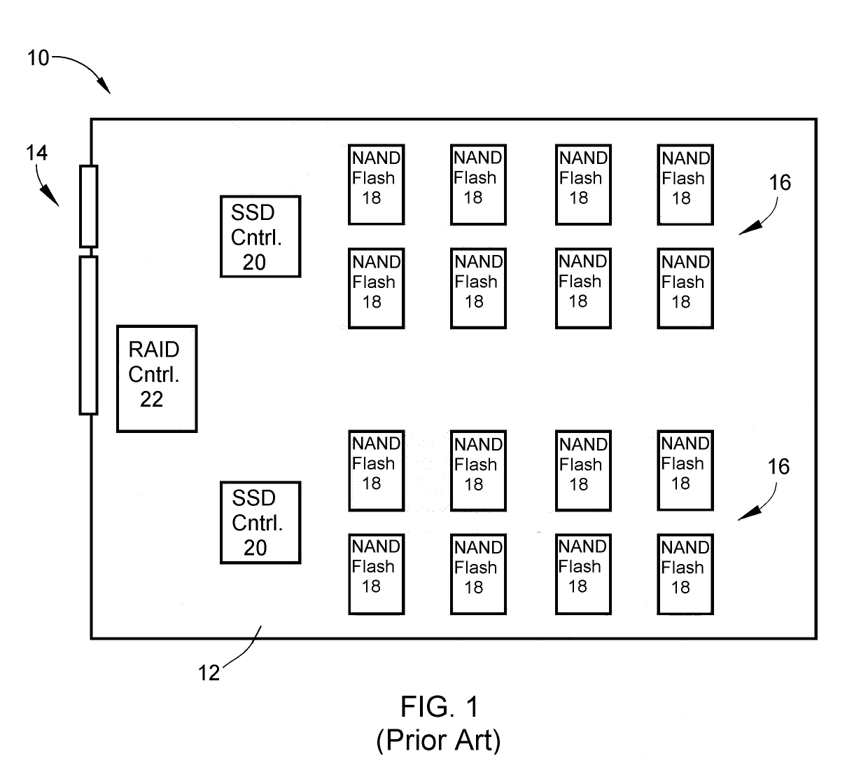

FIG. 2 schematically represents an SSD comprising separate array banks of memory devices, a single SSD controller, and an interposed bank-switch circuitry according to a first embodiment of the invention.

FIG. 3 schematically represents a second embodiment of the invention, in which a flash memory card comprising separate banks of memory devices is adapted to interface with the system logic of a host system through bank switching circuitry without the need for an additional controller on the card.

### DETAILED DESCRIPTION OF THE INVENTION

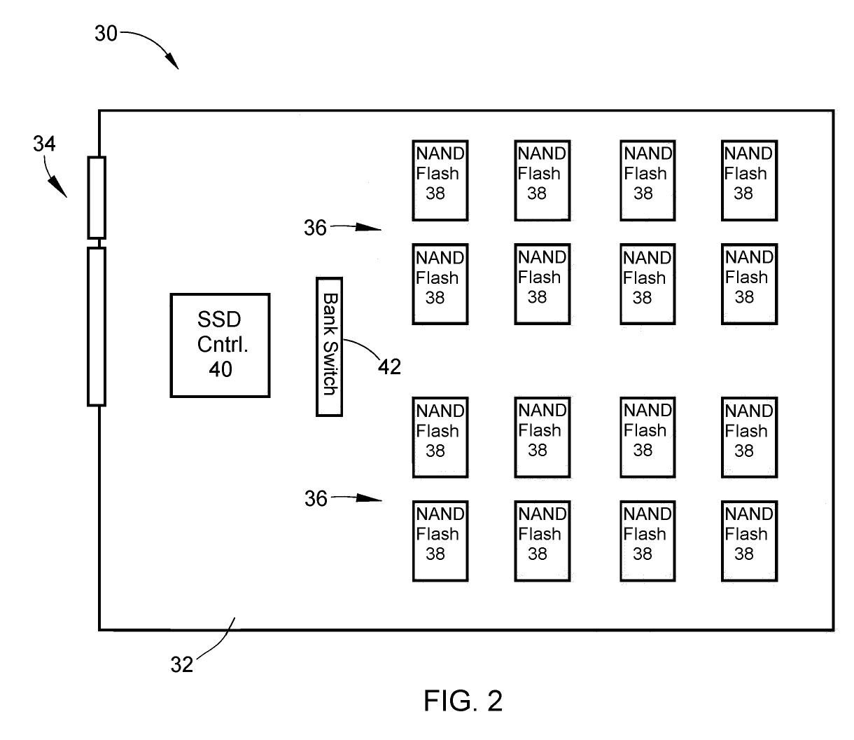

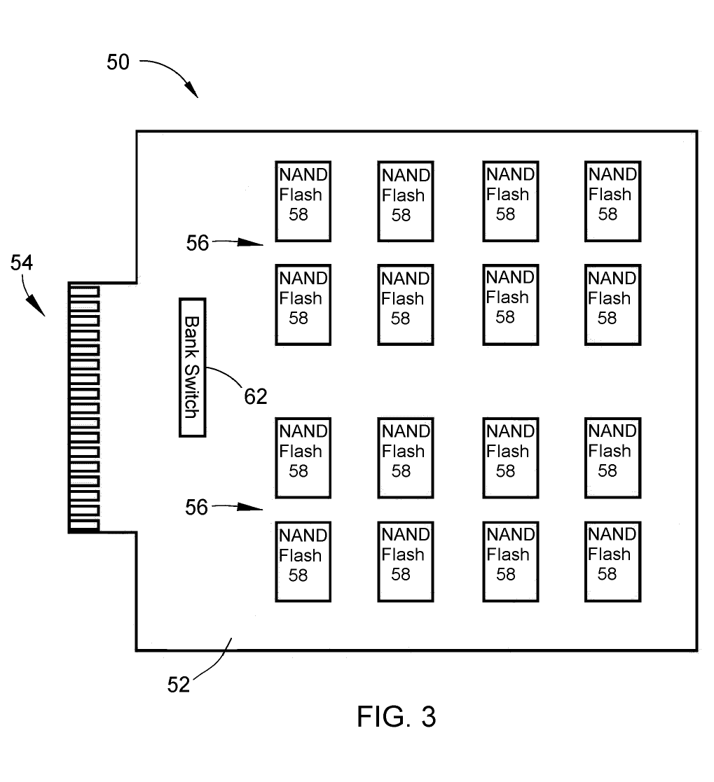

The present invention is generally applicable to computers and other processing apparatuses, and particularly to personal computers, workstations and other apparatuses that utilize nonvolatile (permanent) memory-based mass storage devices, a notable example of which are solid-state drives (SSDs) that make use of NAND flash memory devices. FIGS. 2 and 3 schematically represent SSDs configured as internal mass storage devices for a computer or other host system (not shown) equipped with a data and control bus for interfacing with the SSDs. The bus may operate with any suitable protocol in the art, a preferred example being the serial advanced technology attachment (SATA) bus, though other protocols are also possible.

FIG. 2 shows an SSD 30 as comprising a printed circuit board 32 equipped with a power and data connector 34 and separate banks 36 of memory devices 38 according to one embodiment of the invention. The memory devices 38 are non-volatile memory devices, preferably NAND flash memory devices, though other types of non-volatile memory could be used, including but not limited to NOR flash memory, phase change memory (PCM), magnetic RAM, resistive memory, and FRAM. The SSD 30 further comprises a single memory controller 40 whose electronics bridge the memory devices 38 to the SSD input/output (I/O) interface. In a preferred embodiment, the connector 34 is a SATA interface and the controller 40 is a SATA to solid state drive (SATA-SSD) memory controller, as is well known in the art.

FIG. 2 further shows the SSD 30 as equipped with a bank switching (mapper) circuitry 42 interposed between the banks 36 of memory devices 38 and the controller 40. The addressing of the banks 36 is done through routing the address signals from the controller 40 to the bank switching circuitry 42, which then selects the desired bank 36 for access. The bank switching circuitry 42 may be, for example, a transparent latch, meaning that a change in the input signal to the circuitry 42 causes an immediate change in the output of the circuitry 42, resulting in switching between the banks 36 of memory devices 38. Various techniques are possible by which such a latch can be set or cleared, such as with the controller 40.

Each bank 36 can contain any number of memory devices 38 up to the maximum addressable memory space of the controller 40. The individual banks 36 are electrically isolated from the controller 40, since the bank switching circuitry 42 is between the controller 40 and each bank 36 and therefore receives the primary address signals from the host system through the controller 40, and then generates a secondary set of address signals to the banks 36.

The embodiment of FIG. 2 enables the addressable memory space (domain) of the SSD 30 to be increased by bank-switching, which allows the controller 40 to access a larger physical memory space than it would normally be able to see. Bank switching is well known in the art and has been used in low bandwidth applications like Read-Only addressing of NOR flash memory on the game cartridges, for example, GameBoy® and the Nintendo Entertainment System (NES) commercially available from Nintendo Co., Ltd. In the current invention, bank switching is employed to increase the addressable memory space of the SSD 30 by dividing the non-volatile memory space of the SSD 30 into two or more banks (arrays), thereby increasing the maximum capacity of the SSD 30 beyond the limitation of its controller 40. In view of the discussion above relating to the ability to use a latch to perform the bank switching function of this invention, as well as existing commercial uses of bank switching, components capable of performing the desired bank switching function and their utilization in the manner described herein should be readily understood to those skilled in the art. Therefore, no further details are believed necessary as to the physical nature, operation, and incorporation of the bank switching circuitry 42 into the SSD 30.

As known in the art, NAND flash memory devices have an initial access latency, typically on the order of about 50 to about 100 microseconds, and therefore switching latencies associated with the bank switching circuitry 42 weigh in relatively little compared to the overall response latencies of the memory banks 36. Data buses can be shared between the two banks 36 since only the memory devices 38 of the selected bank 36 are active. A phase lock loop can be used to synchronize clock signals, enabling the bank switching circuitry 42 to be locked into the common clock input and delay propagation of addresses by at least one clock cycle, while preserving the clock edges for easier timing management.

FIG. 3 represents another embodiment in which memory addressing is done on the system level, for example, by a flash memory controller (not shown) that can be integrated on the motherboard of the host computer or else in software using central processor unit (CPU) cycles. In this case, FIG. 3 depicts a flash memory card 50 comprising a printed circuit board 52 equipped with a connector 54 and at least two banks 56 of flash memory devices 58. The memory card 50 can be inserted into a dedicated port or slot on a motherboard (not shown). Similar to the embodiment of FIG. 2, the flash memory card 50 has a bank switching circuitry 62 integrated on the circuit board 52 to address the flash memory devices 58 in the banks 56. The bank switching circuitry 62 receives address and control signals from the system logic of the host system, and then splits these signals between the banks 56 of memory devices 58.

As with the embodiment of FIG. 2, the configuration represented in FIG. 3 allows expanding the addressable memory space beyond that enabled by the control logic at the system level. Other aspects of the memory card 50 and its operation, including the types of connectors 54 and memory devices 58 that can be used and the types and operation of the bank switching circuitry 62, can be as described for the embodiment of FIG. 2.

While certain components are shown and preferred for the non-volatile memory device with multiple banks and a bank switching circuitry of this invention, it is foreseeable that functionally equivalent components could be used or subsequently developed to perform the intended functions of the disclosed components. Therefore, while the invention has been described in terms of a preferred embodiment, it is apparent that other forms could be adopted by one skilled in the art. Finally, while the appended claims recite certain aspects believed to be associated with the invention and indicated by the investigations discussed above, they do not necessarily serve as limitations to the scope of the invention.

1. A non-volatile storage device for use with a host system, the storage device comprising:
a printed circuit board;
at least two banks of non-volatile solid-state memory devices on the printed circuit board;
a single memory controller on the printed circuit board, the memory controller being adapted to interface with the memory devices and a host bus adapter of the host system; and
bank switching circuitry functionally interposed between the memory controller and the at least two banks of the memory devices, the bank switching circuitry operating to switch accesses by the memory controller among the at least two banks.

2. The non-volatile storage device of claim 1, wherein the memory devices are chosen from the group consisting of NAND flash memory, NOR flash memory, phase change memory, magnetic RAM, resistive memory, and FRAM.

3. The non-volatile storage device of claim 1, wherein the memory controller is a SATA-SSD memory controller.

4. The non-volatile storage device of claim 1, wherein the host system is a personal computer or a workstation.

5. The non-volatile storage device of claim 1, wherein the bank switching circuitry comprises a transparent latch.

6. The non-volatile storage device of claim 1, further comprising a phase lock loop that synchronizes clock signals between the memory controller and the bank switching circuitry.

7. A non-volatile mass storage device for use with a host system, the mass storage device comprising:
a printed circuit board;
at least two banks of non-volatile solid-state memory devices on the printed circuit board;
a connector on the printed circuit board adapted to receive address and control signals from a system logic of a host system; and
bank switching circuitry on the printed circuit board and adapted to receive the address and control signals directly from the connector and split at least some of the address and control signals between the at least two banks of the memory devices.

8. The non-volatile mass storage device of claim 7, wherein the memory devices are chosen from the group consisting of NAND flash memory, NOR flash memory, phase change memory, magnetic RAM, resistive memory, and FRAM.

9. The non-volatile mass storage device of claim 7, wherein the connector is a SATA interface.

10. The non-volatile mass storage device of claim 7, wherein the host system is a personal computer or a workstation.

11. The non-volatile mass storage device of claim 7, wherein the bank switching circuitry comprises a transparent latch.

12. The non-volatile mass storage device of claim 7, further comprising a phase lock loop that synchronizes clock signals between the system logic and the bank switching circuitry.

13. A method of increasing addressable memory space of a non-volatile storage device comprising a printed circuit board, at least two banks of non-volatile solid-state memory devices on the printed circuit board, a single memory controller, and a bank switching circuitry, the method comprising:
using the memory controller to interface with a host bus adapter of a host system and the memory devices; and
using the bank switching circuitry to multiply memory space within the memory devices that is addressable by the memory controller by the number of the at least two banks.

14. The method of claim 13, wherein the memory devices are chosen from the group consisting of NAND flash memory, NOR flash memory, phase change memory, magnetic RAM, resistive memory, and FRAM.

15. The method of claim 13, wherein the memory controller is a SATA-SSD memory controller.

16. The method of claim 13, wherein the host system is a personal computer or a workstation.

17. The method of claim 13, wherein the use of the bank switching circuitry comprises using a transparent latch as the bank switching circuitry.

18. The method of claim 13, further comprising using a phase lock loop to synchronize clock signals between the memory controller and the bank switching circuitry.

19. A method of increasing the addressable memory space of a non-volatile solid-state memory card comprising a printed circuit board, at least two banks of non-volatile solid-state memory devices, a connector, and bank switching circuitry, the method comprising:
using the connector to receive address and control signals from a system logic of a host system; and
using the bank switching circuitry to multiply the memory space addressable by the system logic by the number of the at least two banks.

20. The method of claim 19, wherein the memory devices are chosen from the group consisting of NAND flash memory, NOR flash memory, phase change memory, magnetic RAM, resistive memory, and FRAM.

21. The method of claim 19, wherein the connector is a SATA interface.

22. The method of claim 19, wherein the host system is a personal computer or a workstation.

23. The method of claim 19, wherein the use of the bank switching circuitry comprises using a transparent latch as the bank switching circuitry.

24. The method of claim 19, further comprising using a phase lock loop to synchronize clock signals between the system logic and the bank switching circuitry.
